(19) United States
(12) Patent Application Publication
(10) Pub. No.: US 2026/0087506 A1
(43) Pub. Date: Mar. 26, 2026

(54) Energy Accounting System

(71) Applicant: QSecGrid, Inc., New York City, NY (US)

(72) Inventors: Gordon Winston, Katonah, NY (US); John-Philip Galinski, Forest Hills, NY (US); Nigel Walker, Ponteland (GB); Mark Thompson, Blyth (GB); Patrick J.D. Santos, Kirkland, WA (US)

(21) Appl. No.: 19/340,150

(22) Filed: Sep. 25, 2025

Related U.S. Application Data
(60) Provisional application No. 63/699,116, filed on Sep. 25, 2024.

(51) Int. Cl. G06Q 30/018; G06F 21/62; G06Q 10/04; G06Q 50/06; H02J 3/00

(52) U.S. Cl. CPC G06Q 30/018; G06F 21/62; G06Q 10/04; G06Q 50/06; H02J 3/008

(57) ABSTRACT

The present invention relates to managing and certifying energy transactions in an energy accounting system. The present invention provides a framework for receiving energies, organizing, and accounting energy-related transactions of the received energies through a general ledger and a chart of accounts. The present invention further enables tracking of the received energies through cryptographic certificates that are further convertible into exchangeable cryptographic artifacts for trading the energies. The present invention provides an ontology engine that normalizes energy-associated terminology to enable compliance with standardized terminology. A reporting manager generates detailed reports, for example, reports for Sustainable Development Goals (SDG) compliance, carbon net-zero assessments, and other sustainability metrics.

### CROSS-REFERENCE TO RELATED APPLICATIONS

This application claims priority to a commonly owned, U.S. Provisional Ser. No. 63/699,116 , filed on Sep. 25, 2024, and titled “Predictive Energy Management”, which is herein incorporated by reference in its entirety.

### BACKGROUND OF THE INVENTION

Energy is a vital resource. Energy is used for almost every activity ranging from communications, powering homes, fueling industries, transportation, food preparation and so forth. In the cases of commercial, industrial, or business operations, energy is used for the production or manufacturing of goods or providing services. In short, energy is at the heart of economic activity and is therefore critical for survival. Despite its importance, energy management often falls short, leading to inefficiencies, losses during transmission and distribution of energies such as from a power grid to an end user, higher costs, lack of real-time data monitoring, encouraging consumers with incentives for sharing unconsumed energies or generated energies, etc.

Generally, energy management systems help organizations or entities to monitor and optimize their energy consumption, which can further help in reducing higher energy costs. Further, the energy management systems provide a financial report including financial data based on the consumption and other parameters, such as, cost of energy, a type of energy, a duration of energy, and so forth. However, one deficiency in the conventional energy management systems is that they report financial data, such as potential savings, but do not comply with accounting standards such as Generally Accepted Accounting Principles (GAAP), Financial Reporting Standard (FRS), to name a few. While for consumers having less energy consumptions such as residential consumers, such ad-hoc reporting of the financial data may be sufficient. However, when managing large amounts of financial data across multiple consumers and/or large entities, for example, commercial, industrial, and governmental/public applications, this is not sufficient. Further, the conventional energy management systems lack managing and associating energy resources such as power generation or consumption with their costs, for multiple consumers and Virtual Power Plants (VPPs) to have financial transparency.

There is thus a need for a system and method for accounting energies in a more efficient and/or effective manner.

### BRIEF DESCRIPTION OF DRAWINGS

Features and advantages of embodiments of the present invention will become apparent upon consideration of the following detailed description of embodiments thereof, especially when taken in conjunction with the accompanying drawings, and wherein:

FIG. 1 is a block diagram depicting an exemplary computing environment that facilitates management of energies in accordance with at least one embodiment of the present invention.

FIG. 2 is an exemplary functional block diagram of components of an energy management platform in accordance with at least one embodiment of the present invention.

FIG. 3 is an exemplary block diagram of components of an energy accounting system of the energy management platform in accordance with at least one embodiment of the present invention.

FIG. 4 is an exemplary general ledger in accordance with at least one embodiment of the present invention.

FIG. 5 is an exemplary chart of accounts in accordance with at least one embodiment of the present invention.

FIG. 6 is an exemplary process of an Ontology Engine that facilitates normalizing of unknown terms in accordance with at least one embodiment of the present invention.

FIG. 7 is an exemplary process of generating at least one certificate for one or more energies in accordance with at least one embodiment of the present invention.

FIG. 8 is an exemplary process of tokenization of one or more generated certificates in accordance with at least one embodiment of the present invention.

FIG. 9 is an exemplary process of providing recommendations to an energy consumer based on their consumption of energies in accordance with at least one embodiment of the present invention.

FIG. 10 is an exemplary process of generating one or more reports based on one or more energy-related transactions of one or more energy consumers in accordance with at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, “includes”, “such as”, “for instance”, and “for example” mean “including but not limited to”. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION OF THE INVENTION

A method for managing energy transactions in an energy accounting system may include: receiving one or more energies from one or more energy sources; organizing, by a general ledger, a plurality of energy-related transactions for the one or more received energies; indexing, in one or more chart of accounts, the plurality of organized energy-related transactions of the general ledger, based at least in part on a plurality of energy-related attributes of the one or more received energies; and generating, by a certification manager, at least one cryptographic certificate for each of the one or more received energies.

An energy management platform for accounting energies, may include: a general ledger configured to at least organize a plurality of energy-related transactions for one or more received energies from one more energy sources; one or more chart of accounts configured to at least index the plurality of organized energy-related transactions of the general ledger, based on a plurality of energy-related attributes of the one or more received energies; and a certification manager configured to at least generate at least one cryptographic certificate for each of the one or more received energies.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein.

The term “automatic” and variations thereof, as used herein, refers to any suitable process or operation done independent of material human input when the process or operation may be performed. However, a process or operation can be automatic, even though performance of the process or operation uses material or immaterial human input, if the input is received before performance of the process or operation. Human input may be deemed to be material if such input influences how the process or operation will be performed. Human input that consents to the performance of the process or operation may not be deemed to be “material”.

The term “determine” and variations thereof, as used herein, may include suitable type of methodology, process, operation, and/or technique. Such determinations may include calculations and/or computations.

The term “energy source” and variations thereof, as used herein, may be defined as an entity or mechanism responsible for generating or supplying energy. The energy source may include renewable energy sources such as solar panels, wind turbines, and hydroelectric plants, or non-renewable energy sources such as fossil fuel-based generators and nuclear power plants.

The term “energy consumer” and variations thereof, as used herein, may be defined as a responsible person or entity that utilizes or draws energy. Example of the energy consumers include an individual, a business, a utility company, or a grid operator. Each energy consumer may be associated with an energy profile.

The term “energy storage facilities” and variations thereof, as used herein, may be defined as infrastructure, systems, or energy-associated machines that may be capable of storing energy. The storage facilities may function both as energy consumers and energy sources, dynamically shifting roles as needed based on one or more demands, supply conditions, grid requirements, and so forth.

The term “general ledger” and variations thereof, as used herein, may be defined as an accounting system of record for an enterprise or business entity, capable of supporting accounting operations as set forth in GAAP, FRS, and other accounting standards.

The term “user” and variations thereof, as used herein, may be defined as a person or an entity that engages with an energy accounting system to perform functions such as viewing, managing, or analyzing energy transactions, generating reports, or facilitating energy trading. The user may interact with the energy accounting system through a user interface, and the interactions may be logged for audit and compliance purposes.

The term “administrator” and variations thereof, as used herein, may be defined as a person or an entity that may have advanced access rights within the energy accounting system. The administrator may be responsible for tasks such as configuring system settings, managing user accounts and permissions, enabling data integrity, overseeing compliance with regulatory requirements, and maintaining overall system security. The administrator may have an ability to audit transactions, modify system parameters, and troubleshoot technical issues. The actions performed by the administrator may be logged in the energy accounting system for tracking and compliance purposes.

The term “energy characterization” and variations thereof, as used herein, may be defined as a process of describing or defining specific energy-related attributes of energy. The energy characterization may enable the energy-related attributes to be correctly represented and utilized in the energy accounting system.

The term “organization of the energy-related transactions” and variations thereof, as used herein, may be defined as a systematic arrangement of energy-related transactions into a structured format, such as within a general ledger or chart of accounts, for management, indexing, and/or reporting. The organization of the energy-related transactions may allow for an efficient tracking, auditing, and retrieval of data.

The term “energy-related attributes” and variations thereof, as used herein, is defined as distinguishing characteristics or properties of energy related-transactions or certificates. The energy-related attributes may include a type of energy (e.g., renewable or non-renewable), a provenance of energy, a quantity of energy, an energy efficiency rating, an energy source type, a certification status, a provenance, a carbon impact, a time, and other relevant parameters may be used for indexing and reporting in the energy accounting system.

The term “standard” and variations thereof, as used herein, may be defined as a recognized set of guidelines, rules, or metrics used for validating energy transactions and ensuring compliance. Standards may refer to international energy standards, accounting standards, or environmental guidelines such as those related to carbon emissions or sustainability practices.

The term “energies” and variations thereof, as used herein, may be defined as various forms of energy, including electrical energy generated from renewable and non-renewable energy sources. The energies may be categorized based on their provenance of generation, such as solar, wind, hydro, fossil fuel, or nuclear, and may be tracked, managed, and traded within the energy accounting system.

The term “certificate” and variations thereof, as used herein, may be defined as a digital document that certifies the energy-related attributes of one or more energies. The certificates may be generated to validate energy's compliances with certain standards and may be tokenized and/or incorporate cryptographic tokens for use in energy trading.

The term “provenance” and variations thereof, as used herein, may be defined as the documented history or origin of energies, including details about how and where energies were generated, stored, transmitted, and/or consumed. The provenance may enable a traceability and an accountability in energy transactions and may be used to authenticate energy sources, contributing to sustainability and compliance reporting.

The term “energy aggregation” and variations thereof, as used herein, may be defined as a process of combining multiple energies or quantities of energies from one or more energy sources into a unified dataset. The energy aggregation may allow for consolidated reporting and analysis of energy flows and may be utilized in the energy accounting system to manage large volumes of energy data efficiently.

The term “energy reaggregation” and variations thereof, as used herein, may be defined as a process of recombining previously disaggregated or separated energies or quantities of energies into a new, structured dataset. The energy reaggregation may occur for purposes such as recalculating energy balances, updating records in a general ledger, or preparing data for reporting in compliance with updated standards or requirements.

The term “energy disaggregation” and variations thereof, as used herein, may be defined as a process of breaking down aggregated energies or quantities of energies into their component parts. The energy disaggregation may provide detailed insights into individual transactions, source-specific energy contributions, and energy-related attributes, facilitating more granular analysis and reporting in the energy accounting system.

The term “chain of custody” and variations thereof, as used herein, may be defined as a process that enables traceability, accountability, and integrity of energies from their point of origin through to their final destination or consumption. The chain of custody may involve maintaining a transparent and verifiable record of one or more stages of energy's lifecycle, which may include energy generation, energy aggregation, energy storage, energy distribution, energy consumption, energy re-aggregation, energy de-aggregation, and so forth.

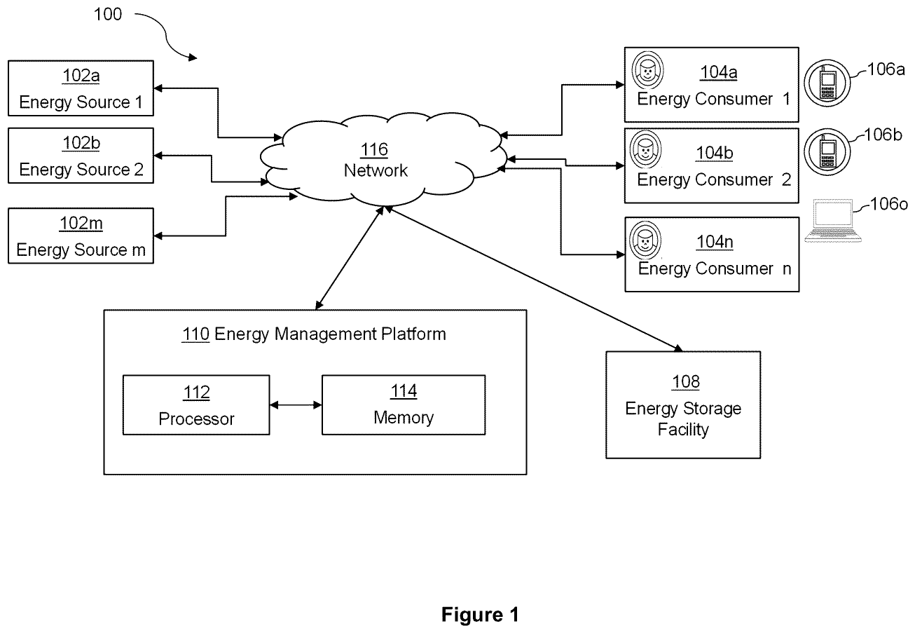

FIG. 1 may be a block diagram depicting an exemplary computing environment 100 for accounting energies, according to at least one embodiment of the present invention. The computing environment 100 may be capable of managing, organizing, and certifying energy-related transactions.

The energy-related transactions may be, for example, an energy generation (i.e., an internal or an external), an energy consumption, an energy transfer, energy storage updates including charging and discharging of an energy storage facility, an energy lending, an energy borrowing, an energy balancing, energy trading activities, energy reconciliation, and so forth. The energy-related transactions may include energy exchanges between different parties, adjustments to energy inventories, and updates to energy credits or debits across various systems.

In an embodiment of the present invention, the computing environment 100 may include a plurality of energy sources 102a-102m (hereinafter referred to as “energy sources 102”or “energy source 102”). The energy sources 102 may be renewable energy sources such as solar panels, wind turbines, and hydropower stations; non-renewable energy sources such as natural gas plants, coal mines, and nuclear power plants; energy storage systems such as batteries or pumped hydro storage; Distributed Energy Resources (DERs) such as power grids, microgrids or localized generators; and external energy markets or third-party suppliers, in an embodiment of the present invention. The energy sources 102 may also include hybrid systems that combine multiple energy generation technologies, in another embodiment of the present invention. Embodiments of the present invention are intended to include or otherwise cover any suitable type of the energy sources 102, including known, related art, and/or later developed technologies that may be beneficial to generate energies.

Further, the computing environment 100 may include a plurality of energy consumers 104a-104n (hereinafter referred to as “energy consumer 104” or “energy consumers 104”). The energy consumers 104 may be residential users, commercial establishments, industrial facilities, electric vehicle charging stations, and utility companies, in an embodiment of the present invention. The energy consumers 104 may also include energy brokers, energy storage systems, and microgrid operators that consume, store, or redistribute energy, in another embodiment of the present invention. Additionally, the energy consumers 104 may involve entities that participate in energy lending, energy borrowing, or trading markets, as well as those who seek to optimize their energy usage based on the sustainability goals, in yet another embodiment of the present invention. Embodiments of the present invention may be intended to include or otherwise cover any suitable energy consumers 104.

The energy consumers 104 may be having one or more energy-associated machines, that may be heat pumps, Heating, Ventilation, and Air Conditioning (HVAC) systems, electrical appliances, such as, refrigerators, washing machines, dishwashers, ovens, and microwaves; generators, electric vehicles, battery storage systems, lighting systems such as LED lights, streetlights, and emergency lighting; air conditioners, water heaters, industrial machinery, such as conveyor belts, pumps, and compressors; automated manufacturing equipment, data centers, computers, mobile phones, smart gadgets, servers, processors, smart home devices, such as, thermostats, smart plugs, and security systems; agricultural equipment, such as irrigation pumps and greenhouse climate control systems; electric forklifts, electric-powered construction tools, electric motors in various applications, and so forth. Embodiments may be intended to include or otherwise cover any suitable type of the energy-associated machines, including known, related art, and/or later developed technologies, ensuring comprehensive coverage across various sectors and industries.

In an embodiment of the present invention, the energy consumers 104 may be having one or more user devices 106a-106o (hereinafter referred to as “user devices 106”). The user devices 106 may enable the energy consumers 104 to interact within the computing environment 100. The user devices 106 may be for example smartphones, tablets, laptops, desktop computers, displays, screens, smart watches, smart speakers, smart thermostats, Internet-of-Things (IoT)-enabled devices, and so forth.

Embodiments may be intended to include or otherwise cover any suitable type of user device 106, including known, related art, and/or later developed technologies.

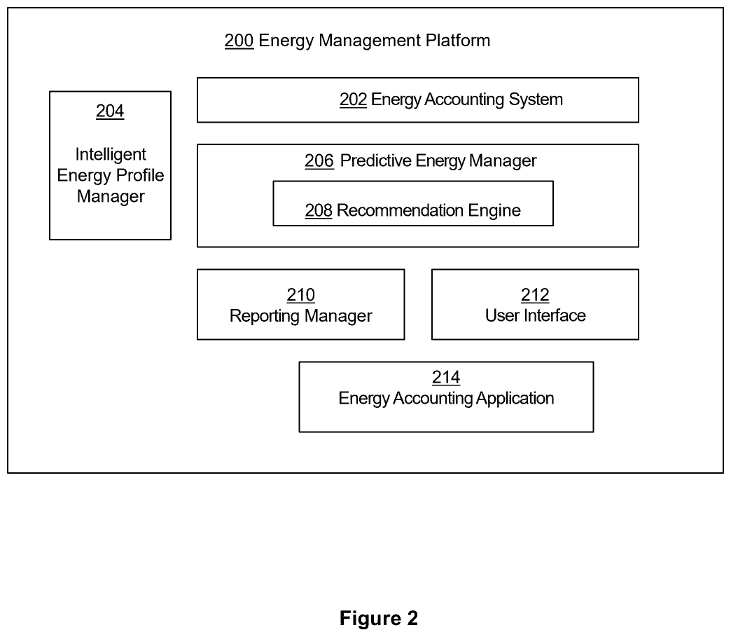

The user devices 106 may enable the energy consumers 104 to access the energy-related transactions, audit logs, reports; receive notifications, recommendations; make informed decisions regarding energy management, and so forth. Further, the user devices 106 may enable the energy consumers 104 to initiate, cease, monitor, regulate, and optimize the energy-related transactions. The user devices 106 may enable the energy consumers 104 to communicate with the computing environment 100 to enable seamless integration with the energy accounting, prediction, and certification processes. The one or more user devices 106 may include a user interface 212 (as shown in FIG. 2) for communication and/or interaction. The working and functioning of the user interface 212 may be explained in detail in the forthcoming description of the FIG. 2.

Further, the user devices 106 may include one or more software applications such as an e-commerce application, a location-based service application, a navigation application, a camera/imaging application, an Optical Character Recognition (OCR) application, a media player application, a social networking application, and the like. In an embodiment of the present invention, the one or more user devices 106 may include an energy accounting application 214 (as shown in the FIG. 2) such that the energy consumers 104 may access one or more of the energy-related transactions, the audit logs, the reports, the notifications, the recommendations and so forth by using log-in credentials. In an embodiment of the present invention, the energy accounting application 214 may be a software application that may be registered with the computing environment 100. The working of the energy accounting application 214 may be described in detail in conjunction with the FIG. 2.

In an embodiment of the present invention, the computing environment 100 may include one or more energy storage facilities 108. The energy storage facilities 108 may be, for example, battery storage systems, pumped hydro storage facilities, flywheels, Compressed Air Energy Storage (CAES), thermal storage units, supercapacitors, gravity-based storage systems, hydrogen-based storage, Liquid Air Energy Storage (LAES), electrochemical storage, thermochemical energy storage, synthetic fuel storage, cryogenic energy storage, and so forth. Embodiments may be intended to include or otherwise cover any suitable type of the energy storage facilities 108, including known, related art, and/or later developed technologies.

According to the embodiments of the present invention, the energy storage facilities 108 may be configured to operate dynamically as either the energy sources 102 or the energy consumers 104 based on real-time demand and supply conditions within the computing environment 100. For example, when energy supply exceeds demand, the energy storage facilities 108 may operate as energy consumers 104 by storing surplus energy. Conversely, during periods of high demand or limited supply, the energy storage facilities 108 may act as energy sources 102 by discharging stored energy back to the grid or to the one or more energy consumers 104. An operational mode and energy flow direction of the energy storage facilities 108 may be controlled by the energy accounting system, according to some embodiments of the present invention.

In an embodiment of the present invention, the computing environment 100 may further include an energy management platform 110. In an embodiment of the present invention, the energy management platform 110 may be a software application stored in a server (not shown). In another embodiment of the present invention, the energy management platform 110 may be implemented as a hardware, a firmware, a software, or a combination thereof, managed by a third-party service provider.

According to an embodiment of the present invention, the energy management platform 110 may be integrated into the one or more energy-associated machines of the energy source 102. In another embodiment of the present invention, the energy management platform 110 may be integrated into the one or more energy-associated machines of the energy consumers 104. In a further embodiment of the present invention, the energy management platform 110 may be deployed on the server that may be a cloud server, an edge computing server, a remote server, a local server, a third-party server, and so forth. Embodiments may be intended to include or otherwise cover any suitable type of the server, including known, related art, and/or later developed technologies.

According to the embodiments of the present invention, the energy management platform 110 may include one or more processor 112 and a memory 114 for storing instructions. In such an embodiment of the present invention, the instructions stored in the memory 114 may be executed by the one or more processor 112 to perform a set of operations of the energy management platform 110.

The instructions may be in form of packages of a computer program code. The code, for example, may be written in a computer programming language that may be compiled into a native instruction set of the processor 112. Further, the code may also be written directly using the native instruction set (e.g., machine language) for executing a set of operations. The set of operations may typically include comparing two or more units of information, shifting positions of units of information, and combining two or more units of information, such as by addition or multiplication or logical operations like OR, exclusive OR (XOR), and AND. Each operation of the set of operations that can be performed by the processor 112 may be represented to the processor 112 by information called instructions, such as an operation code of one or more digits. A sequence of operations to be executed by the processor 112, such as a sequence of operation codes, constitutes processor instructions, also called computer system instructions or, simply, computer instructions. The processor 112 may be implemented as mechanical, electrical, magnetic, optical, chemical, or quantum components, among others, alone or in combination. Embodiments may be intended to include or otherwise cover any suitable implementation of the processor 112, including known, related art, and/or later developed technologies.

According to the embodiments of the present invention, the energy management platform 110 may be configured to manage and record the energy-related transactions for accurate tracking of energy flows among the one or more energy sources 102, the energy consumers 104, and the energy storage facilities 108. The energy management platform 110 may further be configured to generate predictions, recommendations, reports, or a combination thereof, to optimize energy management and decision-making. By leveraging advanced analytics and machine learning models, the energy management platform 110 may be configured to forecast future energy demands, identify potential inefficiencies, and suggest actions to improve energy usage and reduce carbon footprints. Components and the working of the energy management platform 110 may be described in detail in conjunction with the FIG. 2.

Further, the computing environment 100 may include a network 116. According to the embodiments of the present invention, the network 116 may enable communication and data exchange across various users, participants, and components of the computing environment 100.

The network 116 may include a data network such as the Internet, Local Area Network (LAN), Wide Area Network (WAN), Metropolitan Area Network (MAN), etc. In certain embodiments of the present invention, the network 116 may include a wireless network, such as, a cellular network, and may employ various technologies including Enhanced Data Rates For Global Evolution (EDGE), General Packet Radio Service (GPRS), Global System For Mobile Communications (GSM), Internet Protocol Multimedia Subsystem (IMS), Universal Mobile Telecommunications System (UMTS) etc. In some embodiments of the present invention, the network 116 may include or otherwise cover networks or sub-networks, each of which may include, for example, a wired or wireless data pathway. The network 116 may include a circuit-switched voice network, a packet-switched data network, or any other network capable of carrying electronic communications. For example, the network 116 may include networks based on the Internet Protocol (IP) or Asynchronous Transfer Mode (ATM), and may support voice usage, for example, VoIP, Voice-over-ATM, or other comparable protocols used for voice data communications.

Examples of the network 116 may further include a Personal Area Network (PAN), a Storage Area Network (SAN), a Home Area Network (HAN), a Campus Area Network (CAN), a Local Area Network (LAN), a Wide Area Network (WAN), a Metropolitan Area Network (MAN), a Virtual Private Network (VPN), an Enterprise Private Network (EPN), the Internet, a Global Area Network (GAN), and so forth. Embodiments are intended to include or otherwise cover any type of the network 116, including known, related art, and/or later developed technologies to connect the components of the computing environment 100 with each other.

FIG. 2 depicts an exemplary functional block diagram of an energy management platform 200 in accordance with at least one embodiment of the present invention. The energy management platform 200 (FIG. 2) may be an example of the energy management platform 110 (FIG. 1). According to the embodiments of the present invention, the energy management platform 200 may include an energy accounting system 202, an intelligent energy profile manager 204, a predictive energy manager 206, a recommendation engine 208, and a reporting manager 210. Further, the energy management platform 200 may include the user interface 212 and the energy accounting application 214.

In an embodiment of the present invention, the energy accounting system 202 may be configured to record each of the energy-related transactions of the computing environment 100. The energy accounting system 202 may be configured to receive data packets from the energy sources 102, the energy consumers 104, and the energy storage facilities 108 related to the energy-related transactions.

The data packets may include information, such as the energy source 102, the energy consumer 104, the energy storage facilities 108, a type of energy (e.g., renewable or non-renewable), a provenance of energy, a quantity of energy, a value of energy, an energy efficiency rating, an energy source type, a certification status, a provenance, a carbon impact, a date, a time, and so forth. Embodiments are intended to include or otherwise cover any suitable information that may be carried by the data packets, including known, related art, and/or later developed technologies.

The information carried by the data packets may be encrypted for a secure transmission of the information using the network 116. In an embodiment of the present invention, the energy accounting system 202 may be configured to handle the data packets with data processing and security protocols. For instance, upon receiving the data packets from the one or more energy sources 102, the energy consumers 104, and the energy storage facilities 108, the energy accounting system 202 may be configured to decrypt the data packets using decryption algorithms such as, Advanced Encryption Standard (AES), Rivest-Shamir-Adleman (RSA), Elliptic Curve Cryptography (ECC), a symmetric encryption, an asymmetric encryption, and so forth. Embodiments may be intended to include or otherwise cover any suitable decryption algorithms, including known, related art, and/or later developed technologies.

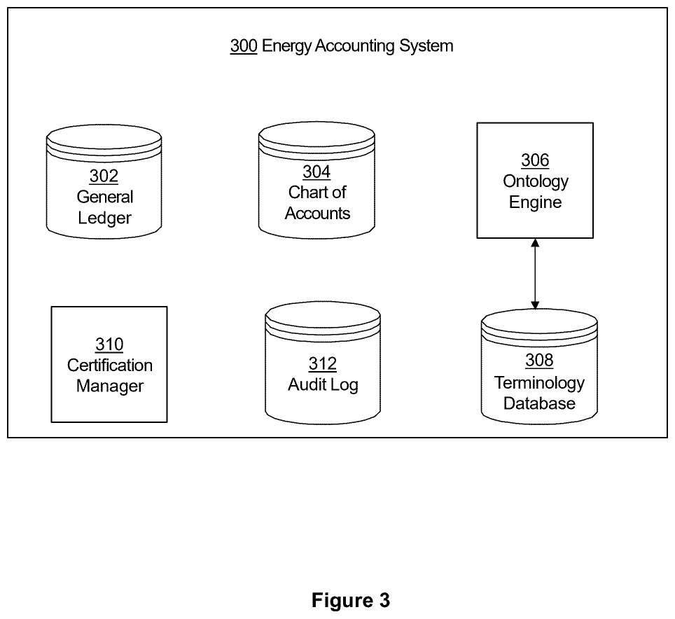

In an embodiment of the present invention, after decryption of the data packets, the energy accounting system 202 may be configured to verify an integrity of the decrypted information by cross-referencing the decrypted information with one or more cryptographic certificates generated by a certification manager 310 (as shown in FIG. 3). The cryptographic certificates may serve as unique identifiers for the one or more energy-related transactions, according to an embodiment of the present invention.

In an embodiment of the present invention, the energy accounting system 202 may be configured to classify the one or more energy-related transactions based on the one or more energy-related attributes of the energies. The energy accounting system 202 may further be configured to log the one or more classified energy-related transactions in a structured format to facilitate efficient retrieval, analysis, and reporting. The energy accounting system 202 may further be configured to index the logged one or more energy-related transactions based on one or more relevant energy-related attributes of the energies. At one instance, the energy accounting system 202 may be configured to index the one or more logged energy-related transactions based on the provenance of energy such as the energies corresponding to the logged energy-related transactions obtained from a renewable energy source, a non-renewable energy source, a hybrid source, and so forth. At another instance, the energy accounting system 202 may be configured to index the logged energy-related transactions based on a chain of custody of energies such as aggregated energies, reaggregated energies, disaggregated energies, and so forth. At yet another instance, the energy accounting system 202 may be configured to index the logged energy-related transactions based on a combination of the one or more relevant energy-related attributes of the energies. The indexing may be performed to enable the energy management platform 200 for efficiently managing large volumes of the energy-related transactions, and may support reporting, compliance checks, predictive analytics, and so forth.

Thus, the energy accounting system 202 may be configured to structure and log the energy-related transactions such that the one or more energies corresponding to the logged energy-related transactions may be tracked for the provenance of energy, since the generation of the energies. By tracking and maintaining a flow of the energies, the energy accounting system 202 may be configured to empower the energy management platform 200 to provide detailed records of energy usage, carbon footprints, efficiency metrics, and so forth. Further, components and the working of the energy accounting system 202 may be described in detail in conjunction with the FIG. 3.

According to an embodiment of the present invention, the intelligent energy profile manager 204 may be configured to generate one or more user profiles based on personal information received from the one or more energy consumers 104, and energy providers. The intelligent energy profile manager 204 may further be configured to integrate the one or more generated user profiles with the general ledger, or the chart of accounts associated with the energy consumers 104 and the energy providers. According to the further embodiment of the present invention, the intelligent energy profile manager 204 may be configured to dynamically generate, store, and manage energy profiles for one or more of the energy consumers 104 of the computing environment 100. Further, the intelligent energy profile manager 204 may be configured to dynamically generate, store, and manage energy profiles for one or more energy providers associated with the energy sources 102 of the computing environment 100.

The intelligent energy profile manager 204 may be configured to estimate the energy profiles based on parameters, such as energy generation, efficiencies, inefficiencies, emissions across various Distributed Energy Resources (DERs), Integrated Distributed Energy Resources (IDERs), historical usage patterns, and so forth. Furthermore, the intelligent energy profile manager 204 may be configured to be integrated with external systems or third-party data sources, such as, billing platforms, carbon tracking databases, and so forth, for fetching real-time data of the one or more of the energy consumers 104.

By aggregating the one or more energy-related attributes or parameters, the real-time data, and the historical usage patterns, the intelligent energy profile manager 204 may be configured to create the profiles that may further be transmitted to the predictive energy manager 206 for predictive analytics, demand forecasting, and optimization of the energies.

According to the embodiments of the present invention, the predictive energy manager 206 may be configured to fetch the organized energy-related transactions from the energy accounting system 202. In another embodiment of the present invention, the predictive energy manager 206 may be configured to fetch the energy profiles of the energy consumers 104 of the computing environment 100 for generating one or more predictions.

The predictive energy manager 206 may further be configured to apply one or more predictive models on the fetched organized energy-related transactions and/or the energy profiles of the energy consumers 104. The one or more predictive models may include, Machine Learning (ML) models, statistical regression models, time-series forecasting models, Artificial Intelligence (AI)-based generative models, and so forth. Embodiments may be intended to include or otherwise cover any suitable predictive models, including known, related art, and/or later developed technologies.

The one or more predictive models may enable the predictive energy manager 206 to analyze historical and real-time data, identify consumption trends, forecast future energy demands, and optimize energy distribution strategies across the computing environment 100.

In certain embodiments of the present invention, the predictive energy manager 206 may be configured to recognize complex patterns within large volumes of the energy-related transactions. The complex patterns may be, for example, seasonal consumption variations, peak demand periods, low demand periods, fluctuations in energy prices, variations in energy consumer behavior, weather-driven demand changes, localized demand trends, patterns associated with specific time-of-use tariffs, energy generation forecasts from renewable energy sources, export patterns, load shedding, curtailment patterns and so forth. Embodiments may be intended to include or otherwise cover any suitable patterns that may be recognized by the predictive energy manager 206, including known, related art, and/or later developed technologies.

In an embodiment of the present invention, the predictive energy manager 206 may include the recommendation engine 208. The recommendation engine 208 may be configured to generate one or more recommendations to enable the energy consumers 104 to make informed decisions under different operational conditions. The recommendation engine 208 may be configured to utilize the one or more predictive models for generating the recommendations based on the recognized complex patterns by the predictive energy manager 206. In an embodiment of the present invention, once the complex patterns may be identified by the predictive energy manager 206, the recommendation engine 208 may consider a range of factors in generating the one or more recommendations. The range of factors may be for example, a historical energy consumption data, weather patterns, user preferences, system load requirements, grid conditions, cost fluctuations, environmental impacts, an availability of renewable energy sources, and so forth. Embodiments may be intended to include or otherwise cover any suitable type of factors in generating the recommendations, including known, related art, and/or later developed technologies.

According to the embodiments of the present invention, the recommendation engine 208 may be configured to provide the recommendations for energy conservation and cost-saving measures by leveraging insights derived from the one or more predictive models. Furthermore, the recommendation engine 208 of the energy management platform 200 may be configured to offer the recommendations on energy procurement strategies, optimal energy storage management, opportunities for the energy trading or lending, and so forth. Embodiments may be intended to cover any suitable type of the recommendations provided by the recommendation engine 208 of the energy management platform 200, including known, related art, and/or later developed technologies.

In an exemplary scenario, the recommendation engine 208 may be configured to generate the recommendations that may focus on reducing carbon emissions and maximizing green energy usage to enable the energy consumers 104 to align the energy consumption with the sustainability goals. For instance, if the predictive energy manager 206 identifies that the patterns showing the peak energy demand coincide with a high carbon intensity on a power grid ‘XG’, then the recommendation engine 208 may suggest strategies to reduce emissions. A possible recommendation by the recommendation engine 208 may be to shift high-energy-consuming activities to times when renewable energy sources, such as a solar plant ‘SP’ or a wind turbine ‘WT’, may be most abundant such as a late morning or early afternoon instead of reliance on the power grid ‘XG’.

In another exemplary scenario, the recommendation engine 208 may advise on an optimal battery storage usage to support green energy consumption. For example, if solar and wind conditions may be forecasted to be favorable in upcoming hours, the recommendation engine 208 may be configured to suggest fully charging a battery storage system during these times. The stored green energy may then be discharged during peak demand hours and may reduce reliance on the power grid ‘XG’, thus lowering carbon emissions.

In a further exemplary scenario, the recommendation engine 208 may be configured to recommend infrastructure enhancements to a facility ‘PWX’. For example, based on current carbon reduction targets and available space in the facility ‘PWX’, the recommendation engine 208 may be configured to propose installing additional solar panels for potentially offsetting a significant portion of the energy needs of the facility ‘PWX’ from non-renewable energy sources and reducing the carbon emissions.

Further, the reporting manager 210 of the energy management platform 200 may be configured to fetch the organized energy-related transactions from the energy accounting system 202, according to an embodiment of the present invention. The reporting manager 210 may be configured to analyze the fetched energy-related transactions to generate one or more reports that may provide insights related to the energy consumption patterns, the carbon footprints, the sustainability goals, the compliance with regulatory standards, and so forth. Embodiments may be intended to include or otherwise cover any suitable type of insights for generating the reports, including known, related art, and/or later developed technologies.

In another embodiment of the present invention, the reporting manager 210 may be configured to generate the reports based on the predictions and the recommendations generated by the predictive energy manager 206.

In an embodiment of the present invention, the reporting manager 210 may be configured to generate one or more reports based on the user preferences. The reporting manager 210 may be configured to enable the energy consumers 104 to select a type of the reports to be generated. Further, the reporting manager 210 may be configured to customize the generated reports according to the user preferences. In a preferred embodiment of the present invention, the generated reports may be of any suitable type such as a Sustainable Development Goal (SDG) compliance report, a carbon net zero report, and so forth. Embodiments may be intended to cover any suitable type of the reports, including known, related art, and/or later developed technologies.

Further, the reporting manager 210 may be configured to enable the energy consumers 104 to access the generated reports in a user selected format of the report. The user selected format may be, a read-only text, a Microsoft Word document (Word), a Portable Document Format (PDF), an animated presentation, a video summary, an interactive chart, a display banner, a social media leaflet, and so forth. Embodiments may be intended to cover any suitable format for accessing the generated reports, including known, related art, and/or later developed technologies.

In an embodiment of the present invention, the user interface 212 of the energy management platform 200 may be configured on the user devices 106 for providing real-time access to one or more of the energy consumption data, a system status, the predictions and the recommendations, one or more generated reports, and so forth, generated by the energy management platform 200. The user interface 212 may be configured to feature interactive elements, such as, graphs, charts, visuals, and alerts to facilitate easy interpretation of the energy-related transactions and the flow of energies in the computing environment 100.

The user interface 212 may be accessible by the energy consumers 104 of the computing environment 100 through the energy accounting application 214. The user interface 212 may enable the energy consumers 104 to interact and/or provide user inputs to the energy management platform 200. According to an embodiment of the present invention, the user interface 212 may be customized for different types of the users including the energy providers, the energy consumers 104, and administrators. In an embodiment of the present invention, the user interface 212 may be a Command Line Interface (CLI), Graphical User Interface (GUI), and so forth. Embodiments of the present invention may be intended to include or otherwise cover any suitable type of the user interface 212, including known, related art, and/or later developed technologies.

Further, the energy accounting application 214 may be installed on the user devices 106. The energy accounting application 214 may be configured to enable the users to select energy-saving preferences, adjust parameters, issue commands to the energy management platform 110, and so forth. The energy accounting application 214 may be configured to enable the users to access the reports, the predictions, and the recommendations generated by the energy management platform 200, track their progress towards energy efficiency goals, collaborate with other users within the computing environment 100, enhancing communication and decision-making, and so forth. Embodiments of the present invention may be intended to include or otherwise cover any suitable functionality of the energy accounting application 214, including known, related art, and/or later developed technologies.

FIG. 3 depicts an exemplary block diagram of the components of the energy accounting system 300 of the energy management platform 110 in accordance with at least one embodiment of the present invention. The components of the energy accounting system 300 may be a general ledger 302, a chart of accounts 304, an ontology engine 306, a terminology database 308, a certification manager 310, and an audit log 312.

According to embodiments of the present invention, the energy accounting system 300 may be configured to log energy-related transactions in the general ledger 302. The general ledger 302 may be a structured format or a database that may be configured to organize the logged energy-related transactions related to the one or more energies that may be transmitted from the energy sources 102, received by the energy consumers 104, transmitted or received by the energy storage facilities 108, aggregated, reaggregated or disaggregated in the computing environment 100 based on the trading of the energies; and so forth. The general ledger 302 may be configured to organize historical energy-related transactions, real-time energy-related transactions, futuristic energy-related transactions related to the energies, and so forth.

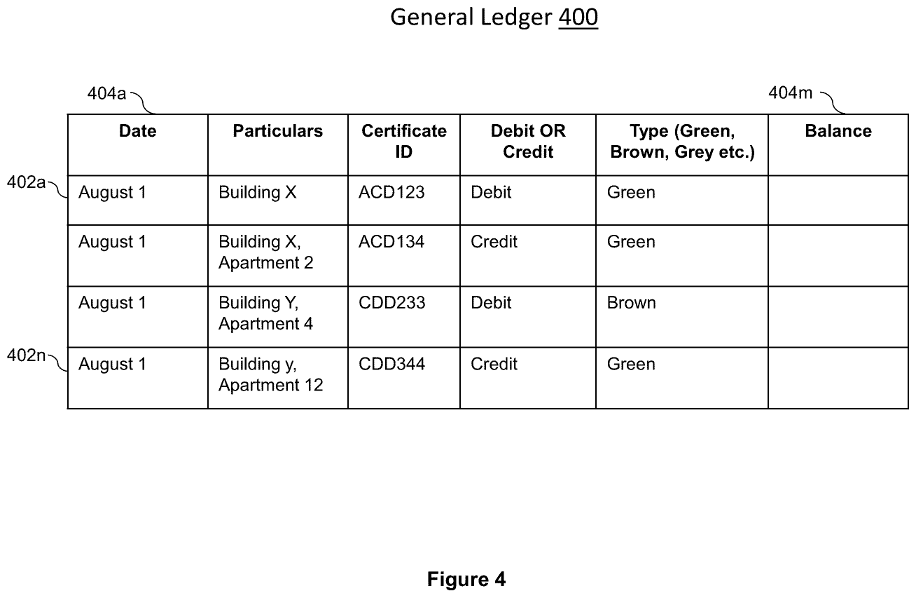

As discussed above, the energy-related transactions may include the information that may be decrypted from the data packets, such as, the energy source 102, the energy consumer 104, the type of energy (e.g., renewable or non-renewable), the provenance of energy, the quantity of energy, the value of energy, the energy efficiency rating, the energy source type, the certification status, the provenance, the carbon impact, the date, the time, and so forth. The information related to the energy-related transactions logged in the general ledger 302 may be accounted for in form of debits and credits. A detailed explanation of the general ledger 302 may be provided in conjunction with the FIG. 4.

The organized information of the energy-related transactions may further be indexed in the chart of accounts 304 based on one or more relevant energy-related attributes of the energies. The chart of accounts 304 may be configured to maintain a hierarchical structure of the energy-related transactions. The chart of accounts 304 may further be configured to enable the indexing of the energy-related transactions in a manner such that the one or more energy-related transactions may be represented as one or more transaction entries within a parent-child hierarchy. The hierarchical structure of the chart of accounts 304 may allow the one or more energy-related transactions to be grouped under broader account categories such as ‘parents’ and then may further be broken down into subcategories ‘children’ for detailed tracking of the energy-related transactions.

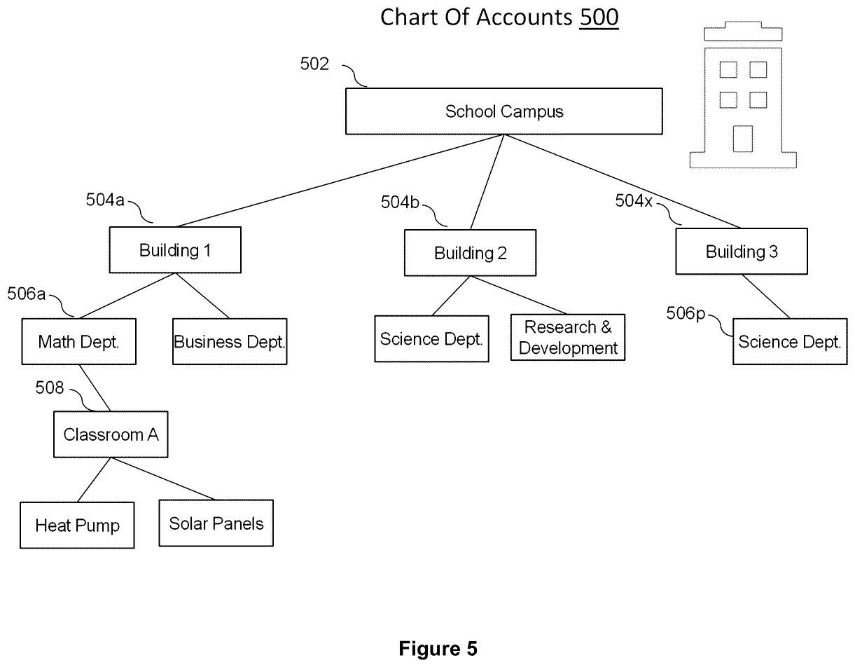

Further, the parent-child hierarchy may allow the children to be tracked and analyzed in relation to a corresponding parent category which may facilitate a structured approach to financial and operational data management. For instance, the energy-related transactions associated with ‘Renewable Energy’ may be indexed under the parent category, while further subcategories, such as ‘Solar Energy,’ ‘Wind Energy,’ and ‘Hydroelectric Energy,’ may be indexed as child accounts. Thereby, the hierarchical structure may support multi-level reporting, compliance auditing, and specific analysis of the one or more energy-related transactions. A detailed explanation of the chart of accounts 304 may be provided in conjunction with the FIG. 5.

According to the embodiment of the present invention, the energy accounting system 300 may be configured to organize the energy-related transactions in the general ledger 302 and index the organized energy-related transactions into the chart of accounts 304 in compliance with one or more accounting standards. The energy accounting system 300 may further be configured to validate the organized energy-related transactions or indexed energy-related transactions in compliance with the one or more accounting standards. The accounting standards may be, Generally Accepted Accounting Principles (GAAP), Financial Reporting Standards (FRS), International Financial Reporting Standards (IFRS), International Accounting Standards (IAS), Japanese Generally Accepted Accounting Principles (J-GAAP), European Union (EU) accounting directives, and so forth. Embodiments of the present invention may be intended to include or otherwise cover any suitable accounting standards, including known, related art, and/or later developed technologies.

According to embodiments of the present invention, the ontology engine 306 may be configured to normalize terminology across the energy accounting system 300. In an embodiment of the present invention, the ontology engine 306 may be configured to normalize the terminology associated with the energy-related transactions decipherable by the general ledger 302 and the chart of accounts 304. The term ‘decipherable’ may refer to an ability of the terminology or data to be clearly understood, interpreted, and processed at least by, with and/or in a context of the general ledger 302 and/or the chart of accounts 304 of the energy accounting system 300 for uniform organization and indexing of the energy-related transactions. For instance, once the data packets of the energy-related transactions may be decrypted by the energy accounting system 300, the ontology engine 306 may be configured to monitor the terminology of the decrypted information.

In an exemplary scenario, upon monitoring, if a term ‘Mic Grid’ may be found to be unknown or deviate from a standard terminology that may be ‘Micro Grid, the ontology engine 306 may be configured to generate a query for the terminology database 308 to find the standard terminology for the deviated term. Based on the found standard terminology for the deviated term, the ontology engine 306 may be configured to transmit a command to the energy accounting system 300 for updating of the terminology ‘Micro Grid’ in place of ‘Mic Grid’ that may further be decipherable by the general ledger 302 and the chart of accounts 304.

According to the embodiments of the present invention, the ontology engine 306 may be configured to notify an administrator to update the terminology database 308, if the deviated term may be unknown or may not be identified from the terminology database 308. The ontology engine 306 may further be configured to integrate new terminologies into the terminology database 308. According to a further embodiment of the present invention, the ontology engine 306 may also be configured to dynamically update relationships and classifications as new types of energies, transaction categories, and the users emerge into the computing environment 100. The new terminologies may be fetched from one or more third-party resources, according to an embodiment of the present invention. In another embodiment of the present invention, the new terminologies may be updated into the terminology database 308 upon intervention by the users.

According to the embodiment of the present invention, the terminology database 308 may serve as a centralized repository for energy-related terms, definitions, descriptors, and so forth, that may be used within the energy accounting system 300. According to embodiments of the present invention, the terminology database 308 may store energy-related terms, such as, terms related to energy sources, transaction types, units of measurement, regulatory standards, and so forth. Embodiments of the present invention may be intended to include or otherwise cover any suitable energy-related terms, including known, related art, and/or later developed technologies.

The terminology database 308 may be, a cloud database, a Comma-Separated Values (CSV) file, an Extensible Markup Language (XML) file, a Relational Database Management System (RDBMS), a JavaScript Object Notation (JSON) file, a structured spreadsheet, a decentralized ledger, and so forth. Embodiments of the present invention may be intended to include or otherwise cover any suitable type of the terminology database 308, including known, related art, and/or later developed technologies.

According to the embodiment of the present invention, the certification manager 310 may be configured to fetch the one or more organized energy-related transactions for the energies received by the energy consumers 104 from the energy accounting system 300. The certification manager 310 may further be configured to analyze the energy-related attributes of the received energies. Based on the analyzed energy-related attributes of the received energies, the certification manager 310 may further be configured to generate one or more cryptographic certificates for the one or more received energies.

In an embodiment of the present invention, the certification manager 310 may be configured to generate the one or more cryptographic certificates for the one or more received energies based on the provenance of the one or more received energies. The provenance of the one or more received energies may be based on a source of each of the received energies such as a green energy source, or a brown energy source. In such an embodiment of the present invention, the provenance of the one or more received energies may be digitally embedded on the one or more generated cryptographic certificates in form of metadata.

In an embodiment of the present invention, the certification manager 310 may further be configured to maintain a chain of custody for each of unconsumed one or more energies by generating at least one new cryptographic certificate for each of the unconsumed one or more energies. In an embodiment of the present invention, the certification manager 310 may further be configured to utilize a blockchain technology, or a distributed ledger technology to enable an immutability and traceability of the provenance of the one or more received energies.

According to the embodiments of the present invention, the certification manager 310 may be configured to enable the energy consumers 104 to tokenize the one or more generated cryptographic certificates. In an embodiment of the present invention, the certification manager 310 may be configured to convert the one or more generated cryptographic certificates into at least one exchangeable cryptographic artifact that may be, a cryptographic token configured for energy trading, a digital certificate of renewable energy generation, a blockchain-based Non-Fungible Token (NFT) representing the energy-related attributes, a smart contract token for enabling automated energy exchange, and so forth. Embodiments of the present invention may be intended to include or otherwise cover any suitable type of the exchangeable cryptographic artifact, including known, related art, and/or later developed technologies.

In an embodiment of the present invention, the certification manager 310 may be configured to manage and verify a certification status of the one or more energy-related transactions within the energy accounting system 300. The certification manager 310 may be configured to validate the one or more energy-related transactions by cross-referencing the one or more energy-related transactions with the audit log 312.

In an embodiment of the present invention, the audit log 312 may be configured to maintain an immutable and traceable record of the one or more generated cryptographic certificates. The audit log 312 may be configured to store the meta data associated with the one or more generated cryptographic certificates for the one or more received energies. The meta data may be a customer identification (ID), a certificate identification (ID), a provenance of energy, a quantity of energy, a characterization of energy, an energy aggregation, an energy re-aggregation, an energy disaggregation of the one or more energies, and so forth. Embodiments of the present invention may be intended to include or otherwise cover any suitable type of the meta data to be stored in the audit log 312, including known, related art, and/or later developed technologies.

According to the embodiment of the present invention, the audit log 312 may be a distributed ledger, a relational database, a cloud-based log, an encrypted file system, and so forth. Embodiments of the present invention may be intended to include or otherwise cover any suitable type of the audit log 312, including known, related art, and/or later developed technologies.

In an exemplary scenario of the present invention, the energy source 102 that may be a wind farm may produce renewable energy, may receive, from the certification manager 310, a cryptographic certificate representing 1 Megawatt-hour (MWh) of the green energy. The certification manager 310 may enable the energy provider of the wind farm to tokenize the cryptographic certificate into an NFT. The tokenized NFT may be used at the energy management platform 110 such as a corporate energy consumer, who may be looking to offset its carbon footprint, may purchase the NFT. Upon purchase, an ownership of the NFT may be transferred to the corporate energy consumer. Based on the transfer of the NFT, the blockchain may record the transfer of the NFT and may further update the audit log 312 to maintain the chain of custody of the green energy.

In another scenario of the present invention, if the corporate energy consumer later decides to re-sell the NFT to another energy consumer within the energy management platform 110, a smart contract embedded within the exchangeable cryptographic artifact may automate the resale and update the ownership in real-time. The transfer or trade of the exchangeable cryptographic artifact may maintain an integrity of the energy provenance, and transaction records remain accessible in the audit log 312 for regulatory audits and carbon accounting to enable the traceability and compliance with energy and sustainability standards.

In yet another scenario of the present invention, the corporate energy consumer, having received 1 megawatt-hour (MWh) of the green energy from the wind farm, may also purchase 5 megawatt-hours (MWh) of brown energy from a power grid. In this case, the certification manager 310 may generate two separate cryptographic certificates for the received energies based on their respective provenances-one representing the green energy and another representing the brown energy.

Further, if there remains an unconsumed portion of the green energy, for example, 0.3 megawatt-hours (MWh), the unconsumed green energy may be re-aggregated on the energy management platform 110. In such a case, the certification manager 310 may be configured to generate a new cryptographic certificate representing the unconsumed 0.3 MWh of green energy, which may then be made available on the energy management platform 110 for further transactions, such as re-aggregation or resale of the green energy, as needed. The certification manager 310 may further be configured to update the audit log 312 to reflect the re-aggregation of the green energy to enable the chain of custody, the provenance, and transaction history of the green energy remain transparent and accessible for regulatory compliance, carbon accounting, and future audits. The described scenarios may be exemplary and may be intended to illustrate potential applications of the present invention. These examples may not be intended to limit the scope of the invention or imply specific implementation requirements. Variations in the setup, energy types, tokenization methods, and use of cryptographic artifacts may apply based on the specific requirements, configurations, and regulatory standards applicable to one or more use cases.

FIG. 4 depicts the general ledger 400, according to at least one exemplary embodiment of the present invention. The general ledger 400 (FIG. 4) may be an example of the general ledger 302 (FIG. 3).

The general ledger 400 may be structured in the form of a table such as the general ledger 400 may include rows 402a-402n (hereinafter referred to as the “row 402” or “rows 402”) and columns 404a-404m (hereinafter referred to as the “column 404” or “columns 404”). Respectively, one or more transaction entries in the rows 402, across the columns 404, may represent one or more distinct energy-related transaction with specific data logged in the general ledger 400.

Further, the one or more rows 402 may correspond to a particular energy-related transaction, while the one or more columns 404 may serve as fields that capture the energy-related attributes of the particular energy-related transaction. The columns 404 may record the data, such as, the time of occurrence of the transaction, particulars such as an asset or a location involved (e.g., specific buildings or apartments), a unique identifier associated with the one or more energy-related transactions, a debit or a credit, the type of energies (e.g., the green energy, the brown energy, or the grey energy, etc.), a balance showing the remaining energy credits or debits, and so forth. Embodiments of the present invention may be intended to include or otherwise cover any suitable type of the data in the columns 404, including known, related art, and/or later developed technologies.

According to another exemplary embodiment of the present invention, the general ledger 400 may be configured to support audit trails and timestamping capabilities for regulatory audits and compliance checks. The one or more transaction entries in the rows 402 may be timestamped to allow tracking of historical records and changes over time.

According to another exemplary embodiment of the present invention, the general ledger 400 may be configured to include data security features, such as, an encryption for the certificate IDs, user access controls, and so forth. Additionally, the general ledger 400 may include analytical tools to generate the insights from the logged energy-related transactions. According to another exemplary embodiment of the present invention, the general ledger 400 may be a versatile and comprehensive tool for tracking the energy-related transactions. The general ledger 400 may be configured to log a wide range of data points across rows 402 and columns 404.

These examples of the general ledger 400 may not be intended to limit the scope of the invention or imply specific implementation requirements.

Embodiments of the present invention may be intended to include or otherwise cover any suitable modification and enhancement in the structure of the general ledger 400, including known, related art, and/or later developed technologies.

FIG. 5 depicts the chart of accounts 500, according to at least one exemplary embodiment of the present invention. The chart of accounts 500 (FIG. 5) may be an example of the chart of accounts 304 (FIG. 3).

The chart of accounts 500 may include a structure that may be in a form of the parent-child hierarchy. In an exemplary scenario of the present invention, the chart of accounts 500 may be configured to log various assets, departments, and resources within a school campus 502. This chart of accounts 500 may start with a top-level entity such as the school campus 502, which may encompass multiple buildings 504a-504x (hereinafter referred to as the “buildings 504”or “building 504”) as primary sub-units.

The buildings 504 may function as an independent unit within the school campus 502, further divided to represent specific departments and facilities. Within each of the buildings 504, one or more departments 506a-506p (hereinafter referred to as the “department 506” or “departments 506”) may be identified, that may be a math department 506a, a science department, and so forth. There may be designated classrooms 508 in each of the departments 506. Further, each of the designated classrooms 508 in the one or more department 506 may be having the energy-associated machines, such as the Heat Pump, the Solar Panels, and so forth.

According to the embodiments of the present invention, the chart of accounts 500 may be configured to index and display the parent-child hierarchy such as a clear, visual representation of the location of the one or more energy-associated machines and its relationship within the school campus 502. For example, by selecting a building such as Building 504a, the user may drill down to view the departments 506, such as the Math Department 506a or Business Department, and within the one or more department 506, specific classrooms 508 and the energy-associated machines (e.g., Heat Pump, Solar Panels) may be displayed. This capability may enable the users to assess resource allocation, track the energy consumption, schedule maintenance activities, and so forth.

According to some embodiments of the present invention, the chart of accounts 500 may display real-time data on energy generation, consumption, and available surplus within the one or more departments 506 and may enable campus administrators to monitor and manage energy flows across the school campus 502. For example, the campus administrators may navigate through the chart of accounts 500 to view the energy consumption levels in the one or more classrooms 506, identify excess energy production in specific areas, and facilitate the transfer of that energy to other departments 506 in need. By selecting the cryptographic certificate associated with an excess energy or unconsumed energy in a particular department 506, the campus administrators may initiate an energy transfer, which may be then recorded in the general ledger 400 of the energy management platform 110 and may further be indexed into the chart of accounts 500.

In another embodiment of the present invention, the chart of accounts 500 may include filtering and reporting functionalities to analyze resources based on categories like the department 506, building 504, or an asset type. Additionally, the chart of accounts 500 may incorporate real-time data integration, allowing for updates to assets, such as adding or removing specific equipment (e.g., replacing Solar Panels in a classroom), and instantly reflecting those changes across hierarchical views. This may facilitate accurate and up-to-date record-keeping such that the school campus resources may effectively be tracked and managed over time. These examples of the chart of accounts 500 may not be intended to limit the scope of the invention or imply specific implementation requirements.

Embodiments of the present invention may be intended to include or otherwise cover any suitable modification and enhancement in the structure of the chart of accounts 500, including known, related art, and/or later developed technologies.

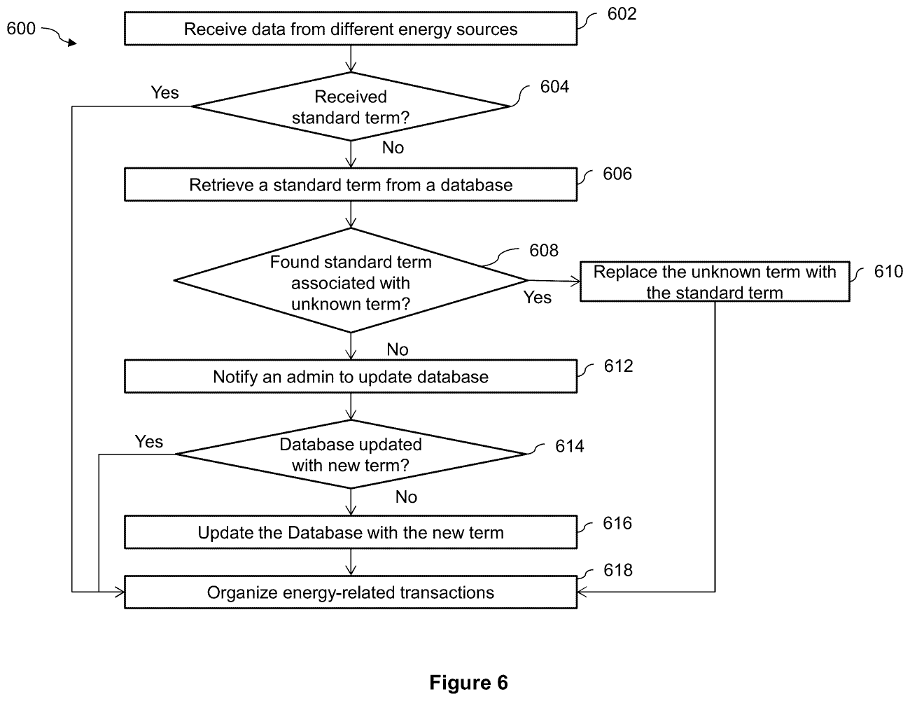

FIGS. 6-10 present illustrative one or more processes 600-1000 for implementing energy accounting systems in accordance with at least one embodiment of the present invention. The one or more processes 600-1000 may be illustrated as a collection of blocks in a logical flowchart, which represents a sequence of operations that may be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations may be described may not be intended to be construed as a limitation, and any suitable number of the described blocks may be combined in any suitable order and/or in parallel to implement the process.

FIG. 6 may be an exemplary process 600 that relates to operations of the ontology engine 306 to facilitate the normalizing of unknown terms in accordance with at least one embodiment of the present invention. At 602 block, the energy management platform 110 may receive data from the one or more energy sources 102.

At 604 block, the energy management platform 110 may determine whether one or more standard terms are received in the received data or not. In case, the energy management platform 110 may receive one or more standard terms then the process 600 may proceed to a 618 block. In case, the energy management platform 110 may not receive one or more standard terms and instead receive one or more unknown terms, then the energy management platform 110 proceeds to a 606 block.

At the 606 block, the energy management platform 110 may retrieve one or more standard terms for the received unknown term from the terminology database 308.

At the 608 block, the energy management platform 110 may determine whether the one or more standard terms associated with the one or more unknown terms may be found in the terminology database 308 or not. In case, the energy management platform 110 may determine that the one or more standard terms associated with the one or more unknown terms may be found in the terminology database 308, then the process 600 may proceed to a 610 block and may replace the unknown term with the standard term stored in the terminology database 308 and then the process 600 may proceed to the 618 block. In case, the energy management platform 110 may determine that the one or more standard terms associated with the one or more unknown terms may not be found in the terminology database 308, then the process 600 may proceed to a 612 block.

At the 612 block, the energy management platform 110 may notify an administrator regarding the unknown terms received in the data. In an embodiment of the present invention, the administrator may be a person. In another embodiment of the present invention, the administrator may be an automated tool such as a machine learning tool in order to identify one or more synonyms.

Further, at 614 block, the energy management platform 110 may determine whether the terminology database 306 may be updated with one or more standard terms associated with the unknown terms or not. In case, the energy management platform 110 may determine that the terminology database 308 may be updated with the one or more standard terms associated with the unknown terms, then the process 600 may conclude. In case, the energy management platform 110 may determine that the terminology database 306 is not updated with one or more standard terms associated with the unknown terms, then the process 600 may proceed to a 616 block and update the terminology database 308.

At the 616 block, the energy management platform 110 may update the terminology database 308 with the new terms that may be the standard terms associated with the unknown terms.

At the 618 block, the energy management platform 110 may organize the energy-related transactions based on the outputs of the ontology engine 306 to facilitate the normalizing of unknown terms. Thereby, the energy management platform 110 may enable a consistency and the standardization in the logged energy-related transactions that may be decipherable by the general ledger 302 and the one or more chart of accounts 304 for further analysis and processing.

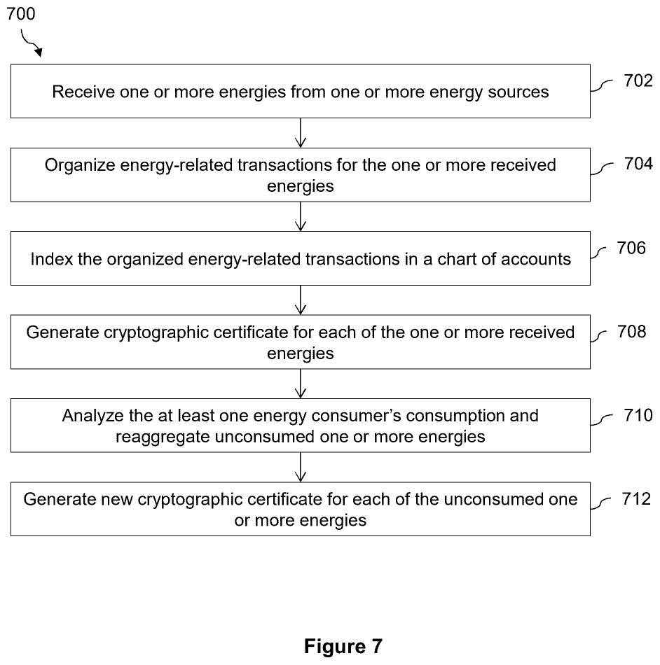

FIG. 7 may be an exemplary process 700 that relates to a generation of at least one certificate for each of the one or more energies in accordance with at least one embodiment of the present invention.

At 702 block, the energy management platform 110 may receive one or more energies from one or more energy sources 102 or the energy storage facilities 108. As discussed above, the one or more energies may be for example, a green energy, or a brown energy. As discussed above, the one or more energy sources 102 may include, renewable energy sources such as solar panels, wind turbines, and hydroelectric plants, or non-renewable energy sources such as fossil fuel-based generators and nuclear power plants.

At 704 block, the energy management platform 110 may organize one or more energy-related transactions for the one or more received energies.

At 706 block, the energy management platform 110 may index the organized energy-related transactions in the chart of accounts 304.

Further, at 708 block, the energy management platform 110 may generate a cryptographic certificate for each of the one or more received energies. The cryptographic certificate of the one or more received energies may include a representation of energy-related attributes for example, a type of energy (e.g., renewable or non-renewable), a provenance of energy, a quantity of energy, an energy efficiency rating, a source type, a certification status, a carbon impact, a time stamp, and so forth. Once the cryptographic certificate may be generated, the energy may be transferred along with the certificate to an energy consumer 104. As an exemplary scenario, in case the energy consumer 104 is receiving a green energy ‘G1’ from an energy source “S1” and a brown energy “B1” from an energy source “S2”, then the energy management platform 110 may generate two difference cryptographic certificates ‘CG1’ and ‘CB1’ for each of the energies ‘G1’ and ‘B1’ and transmit the cryptographic certificate ‘CG1’ with the green energy ‘G1’ and the cryptographic certificates ‘CB1’ with the brown energy ‘B1’.

Further, at 710 block, the energy management platform 110 may analyze a consumption of the one or more received energies by the energy consumer 104 or the energy storage facilities 108. The energy management platform 110 may then reaggregate the unconsumed energy. In the above exemplary scenario, in case the energy consumer 104 consumed 50% of the green energy ‘G1’ and 20% of the brown energy ‘B1’, then the energy management platform 110 may reaggregate the remaining 50% of the green energy ‘G1’ and 80% of the brown energy ‘B1’.

Next, at 712 block, the energy management platform 110 may generate a new cryptographic certificate for each of the reaggregated unconsumed energies. As in the above exemplary scenario, the energy management platform 110 may generate a new cryptographic certificate ‘CG2’ and ‘CB2’ for each of the reaggregated energies i.e. reaggregated green energy ‘G2’ that may be 50% of the green energy ‘G1’ and reaggregated brown energy ‘B2’ that may be 80% of the brown energy ‘B1’. The generated new cryptographic certificate for the reaggregated unconsumed energies may further be tokenized into at least one exchangeable cryptographic artifact. The generated new cryptographic certificate may also be recorded in the audit log 312, for example, the audit log 312 may store one or more items of meta data of the new cryptographic certificate to maintain the chain of custody for one or more energy-related transactions. Additionally, there may be other processes that may require the generated new cryptographic certificate for validation, tracking, or compliance purposes based on specific needs of the energy management platform 110.

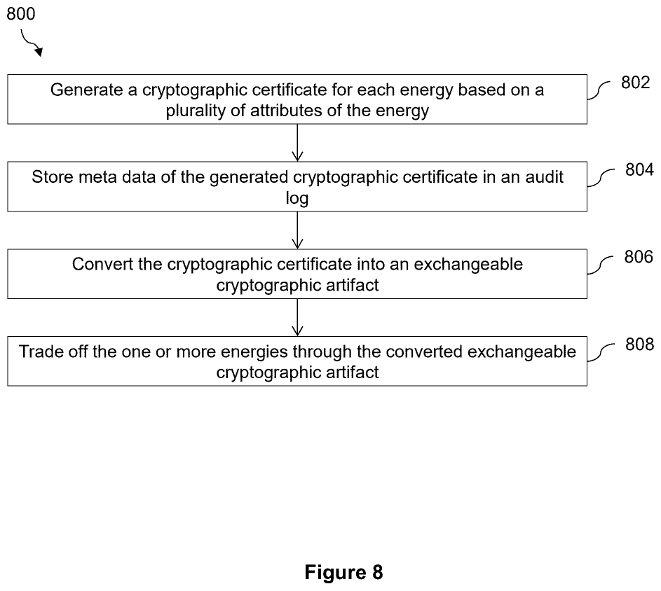

FIG. 8 may be an exemplary process 800 of tokenization of one or more generated certificates in accordance with at least one embodiment of the present invention. At 802 block, the energy management platform 110 may generate a cryptographic certificate for each of the one or more received energies based on the energy-related attributes of each of the one or more received energies.

At 804 block, the energy management platform 110 may store meta data of each of the generated cryptographic certificates. In an embodiment of the present invention, the energy management platform 110 may store meta data of each of the generated cryptographic certificate in the audit log 310. As discussed above, the audit log 310 may store the meta data associated with the energy-related attributes of each of the one or more energies whose cryptographic certificates may be generated. The meta data may be for example, an energy customer identification (ID), a certificate identification (ID), a provenance of energy, a quantity of energy, a characterization of energy, an energy aggregation, an energy re-aggregation, an energy disaggregation of the one or more energies, and a combination thereof.

At 806 block, the energy management platform 110 may convert each of the generated cryptographic certificate may be tokenized that further converted into an exchangeable cryptographic artifact.

At 808 block, the energy management platform 110 may enable one or more energy consumers 104 to trade off the one or more energies (e.g., generated or unconsumed) using the exchangeable cryptographic artifact. The exchangeable cryptographic artifact may be traded by the energy consumers 104 in exchange of the one or more energies. In some embodiments of the present invention, the tokens may underlie a cryptographic currency. In other embodiments of the present invention, the tokens may be traded in of themselves. Further, the energy management platform 110 may be configured to create a log or a record in the audit log 312 associated with the energy consumer 104 and may then track the utilization of the energy consumed. In case, the energy underlying the token is consumed by the energy consumer 104, the record of the token is either destroyed or deactivated.

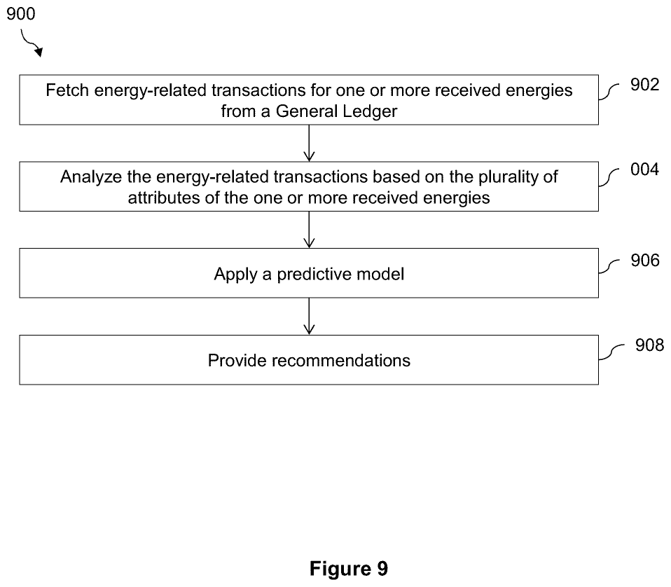

FIG. 9 may be an exemplary process 900 of providing the recommendations to an energy consumer 104 based on their consumption of energies in accordance with at least one embodiment of the present invention.

At 902 block, the energy management platform 110 may fetch energy-related transactions associated with the energy consumer 104. In an embodiment of the present invention, the energy-related transactions may be fetched for one or more energies associated with the energy consumer 104. The energy-related transactions may be fetched from the general ledger 302 maintained by the energy accounting system 300.

At 904 block, the energy management platform 110 may analyze the fetched one or more energy-related transactions. In an embodiment of the present invention, the energy management platform 110 may analyze the fetched one or more energy-related transactions based on the energy-related attributes of the one or more energies consumed by the energy consumer 104.

At 906 block, the energy management platform 110 may apply a predictive model. The predictive model may be configured to generate one or more results based on the analyzed energy-related transactions.

At 908 block, the energy management platform 110 may generate one or more recommendations. For example, the recommendations may be based at least in part on the results generated by the predictive model. The one or more recommendations may be generated to enable the energy consumers to make informed decisions under different operational conditions. The recommendations may be provided on one or more of energy procurement strategies, optimal energy storage management, opportunities for energy trading or lending, and so forth. However, the energy management platform 110 may take into consideration a number of factors in order to generate one or more recommendations, which may be, for example, a historical energy consumption data, weather patterns, user preferences, system load requirements, grid conditions, cost fluctuations, environmental impacts, an availability of renewable energy sources, and so forth.

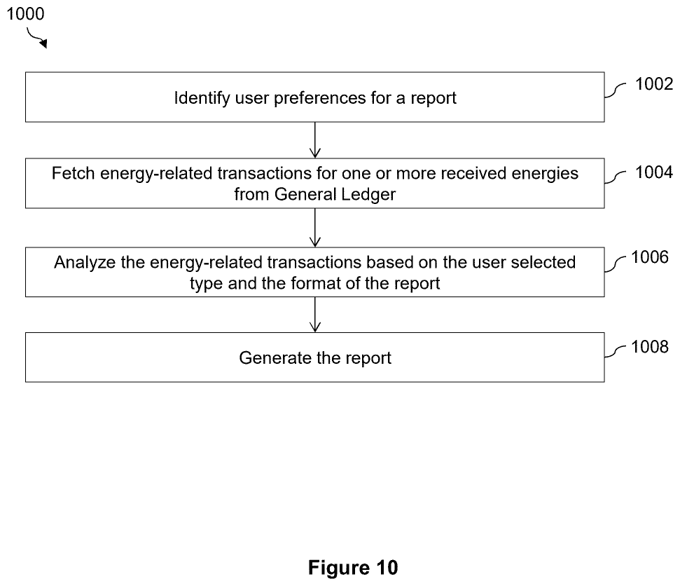

FIG. 10 is an exemplary process 1000 of generating one or more reports based on one or more energy-related transactions of each energy consumer in accordance with at least one embodiment of the present invention.

At 1002 block, the energy management platform 110 may identify one or more user preferences for receiving a report. The user may be for example an energy consumer, an energy provider, a regulatory body, and so forth. In an embodiment of the present invention, the user preferences may be for example, a type of a report, a format of a report, and so forth. The energy management platform 110 may enable an energy user to select one or more preferences for the report. As discussed above, a type of report may be a Sustainable Development Goal (SDG) compliance report, a carbon net zero report, and so forth. The format of the report may be a read-only text, a Microsoft Word document (Word), a Portable Document Format (PDF), an animated presentation, a video summary, an interactive chart, a display banner, a social media leaflet, and so forth.

At 1004 block, the energy management platform 110 may fetch the energy-related transactions associated with the energy user. In an embodiment of the present invention, the energy-related transactions may be fetched for one or more energies associated with the energy user. The energy-related transactions may be fetched from the general ledger 302 maintained by the energy accounting system 300.

At 1006 block, the energy management platform 110 may analyze the fetched one or more energy-related transactions. In an embodiment of the present invention, the energy management platform 110 may analyze the fetched one or more energy-related transactions based on the energy-related attributes of the one or more energies consumed by the energy consumer, energies generated and shared by the users, and so forth.

Further, at 1008 block, the energy management platform 110 may generate at least one report. For example, the report(s) may be based at least in part on the analyzed one or more energy-related transactions. The generated reports may be a Sustainable Development Goal (SDG) compliance report, a carbon net zero report, and so forth. The generated at least one report may be in compliance with the regulatory standards.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for managing energy transactions in an energy accounting system, comprising:
receiving one or more energies from one or more energy sources; and
by execution of computer-executable instructions on at least one computing device:
organizing, by a general ledger, a plurality of energy-related transactions for the one or more received energies;
indexing, in one or more chart of accounts, the plurality of organized energy-related transactions of the general ledger, based at least in part on a plurality of energy-related attributes of the one or more received energies; and
generating, by a certification manager, at least one cryptographic certificate for each of the one or more received energies.

2. The method of claim 1, further comprising and by execution of computer-executable instructions on the at least one computing device, validating, the general ledger and the one or more chart of accounts in compliance with at least one accounting standard.

3. The method of claim 1, further comprising and by execution of computer-executable instructions on the at least one computing device, normalizing, by an ontology engine, one or more received energy-related terms at least in part by querying a terminology database to match the one or more received energy-related terms to corresponding standardized terminology decipherable by the general ledger and the one or more chart of accounts.

4. The method of claim 1, further comprising and by execution of computer-executable instructions on the at least one computing device, generating, by a reporting manager, a plurality of reports based on the plurality of the organized energy-related transactions based at least in part on the general ledger.

5. The method of claim 4, wherein the plurality of reports is selected from a Sustainable Development Goal (SDG) compliance report, a carbon net zero report, or a combination thereof.

6. The method of claim 1, further comprising and by execution of computer-executable instructions on the at least one computing device:
generating, by an intelligent energy profile manager, at least one user profile for each energy consumer; and
integrating the at least one generated user profile with one or more of the general ledger, the one or more chart of accounts, or a combination thereof, associated with the energy consumer.

7. The method of claim 1, comprising and by execution of computer-executable instructions on the at least one computing device:
analyzing, by a predictive energy manager, the plurality of energy-related transactions for the one or more received energies; and
providing one or more recommendations based at least in part on at least one predictive model.

8. The method of claim 1, comprising and by execution of computer-executable instructions on the at least one computing device, maintaining a chain of custody for each of unconsumed one or more energies by generating at least one new cryptographic certificate for each of the unconsumed one or more energies.

9. The method of claim 8, comprising and by execution of computer-executable instructions on the at least one computing device, generating at least one audit log such that the at least one generated cryptographic certificate for each of the one or more received energies is logged into the at least one generated audit log.

10. The method of claim 9, wherein the at least one generated audit log is configured to store metadata associated with the plurality of energy-related attributes of the one or more energies, the metadata including one or more of: a customer ID, a certificate ID, provenance, quantity, energy characterization, energy aggregation, energy re-aggregation, energy disaggregation of the one or more energies, and a combination thereof.

11. The method of claim 1, comprising and by execution of computer-executable instructions on the at least one computing device, tokenizing, by the certification manager, the at least one generated cryptographic certificate into at least one exchangeable cryptographic artifact.

12. The method of claim 11, wherein the at least one exchangeable cryptographic artifact is selected from: a cryptographic token configured for energy trading, a digital certificate of renewable energy generation, a blockchain-based Non-Fungible Token (NFT) representing the energy-related attributes, a smart contract token enabling automated energy exchange, or a combination thereof.

13. An computer-implemented energy management platform for accounting energies, comprising:
a computer-executable general ledger configured to at least organize a plurality of energy-related transactions for one or more received energies from one more energy sources;
one or more chart of accounts configured to at least index the plurality of organized energy-related transactions of the general ledger, based on a plurality of energy-related attributes of the one or more received energies; and
a certification manager configured to at least generate at least one cryptographic certificate for each of the one or more received energies.

14. The energy management platform of claim 13, further comprising a computer-executable ontology engine configured at least to normalize one or more received energy-related terms, at least in part by querying a terminology database, to match the one or more received energy-related terms to corresponding standardized terminology decipherable by the general ledger and the one or more chart of accounts.

15. The energy management platform of claim 13, further comprising a computer-executable reporting manager configured at least to generate a plurality of reports based at least in part on the plurality of the organized energy-related transactions from the general ledger.

16. The energy management platform of claim 13, further comprising a computer-executable intelligent energy profile manager configured at least to generate at least one user profile for each energy consumer wherein the at least one generated user profile is integrated with one or more of the general ledger, the one or more chart of accounts, or a combination thereof, associated with the energy consumer.

17. The energy management platform of claim 13, further comprising a computer-executable certification manager configured at least to tokenize the at least one generated cryptographic certificate into at least one exchangeable cryptographic artifact.

18. The energy management platform of claim 13, wherein the at least one cryptographic certificate comprises metadata, representing at least one provenance of the one or more received energies, selected from a green energy source, and a brown energy source.

19. The energy management platform of claim 13, further comprising a computer-executable predictive energy manager configured at least to:
analyze the plurality of energy-related transactions for the one or more received energies; and
provide one or more recommendations based on at least one predictive model.

20. One or more computer-readable storage media collectively having thereon computer-executable instructions that, when executed, collectively cause one or more computers to, at least:
receive one or more energies from one or more energy sources;
organize, by a general ledger, a plurality of energy-related transactions for the one or more received energies;
index, in one or more chart of accounts, the plurality of organized energy-related transactions of the general ledger, based at least in part on a plurality of energy-related attributes of the one or more received energies; and
generate, by a certification manager, at least one cryptographic certificate for each of the one or more received energies.
